(19) United States
(12) Patent Application Publication
(10) Pub. No.: US 2017/0019522 A1
(43) Pub. Date: Jan. 19, 2017

(54) ELECTRONIC APPARATUS AND COMMUNICATING METHOD THEREOF

(71) Applicant: Samsung Electronics Co., Ltd, Gyeonggi-do (KR)

(72) Inventor: Gyuchual Kim, Gyeonggi-do (KR)

(21) Appl. No.: 15/212,118

(22) Filed: Jul. 15, 2016

(30) Foreign Application Priority Data
Jul. 16, 2015 (KR) 10-2015-0101275

(51) Int. Cl. H04M 1/725; G06T 13/80; G06F 3/16; G06F 3/0488; G06F 3/01

(52) U.S. Cl. CPC H04M 1/72555; G06F 3/04883; G06F 3/016; G06F 3/167; G06T 13/80; H04M 2250/22; H04M 2250/20; G06F 2203/04808

(57) ABSTRACT

An electronic device and a communication method thereof according to an exemplary embodiment of the present invention are configured for displaying an identification image associated with identification data, recording sensitivity data for outputting an object to the identification image on a basis of a user input that is input in association with the identification image, and transmitting the recorded sensitivity data.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jul. 16, 2015 and assigned Serial No. 10-2015-0101275, the entire disclosure of which is hereby incorporated by reference.

### TECHNICAL FIELD

The present invention relates to an electronic device and an operating method thereof, and in particular, to an electronic device and a communication method thereof.

### BACKGROUND

In general, various functions are added to an electronic device to perform a complex function. For example, the electronic device may perform a mobile communication function, a data communication function, a data output function, a data storage function, an image capturing function, a voice recording function, or the like. The electronic device includes a display unit and an input unit. In this case, the display unit and the input unit may be coupled to implement a touch screen. Further, the electronic device may output a display screen through the display unit. Furthermore, the electronic device may control the display screen by detecting a touch in the display screen.

However, the aforementioned electronic device does not provide various interactions as to various touch operations. As a result, the electronic device has a difficulty in controlling a display screen in association with the various touch operations. Accordingly, there is a problem in that usage efficiency and user convenience of the electronic device are low.

### SUMMARY

To address the above-discussed deficiencies, it is a primary object to provide a communication method of an electronic device includes displaying an identification image associated with identification data, recording sensitivity data for outputting an object to the identification image on a basis of a user input that is input in association with the identification image, and transmitting the recorded sensitivity data.

According to an exemplary embodiment of the present invention, an electronic device includes a communication unit, a display unit, and a controller coupled to the communication unit and the display unit, wherein the controller controls to display an identification image associated with identification data, record sensitivity data for outputting an object to the identification image on a basis of a user input that is input in association with the identification image, and transmit the recorded sensitivity data.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an electronic device according to various embodiments of the present invention;

FIGS. 2A and 2B illustrate an example of implementing an electronic device according to various embodiments of the present invention;

FIG. 3 illustrates a procedure of performing a communication method of an electronic device according to various embodiments of the present invention;

FIG. 4 illustrates a procedure of performing an edge communication function execution operation of FIG. 3 according to various embodiments of the present disclosure;

FIG. 5 illustrates a procedure of performing a sensitivity data generation operation of FIG. 4 according to various embodiments of the present disclosure;

FIG. 6 illustrates a procedure of performing a communication event notification operation of FIG. 3 according to various embodiments of the present disclosure;

FIG. 7 illustrates a first example of a procedure of performing a communication event confirmation operation of FIG. 3 according to various embodiments of the present disclosure;

FIG. 8 illustrates a second example of a procedure of performing a communication event confirmation operation of FIG. 3 according to various embodiments of the present disclosure; and

FIG. 9, FIG. 10, FIG. 11, FIG. 12A, FIG. 12B, FIG. 13, FIG. 14, FIG. 15, FIG. 16, FIG. 17, FIG. 18, FIG. 19, FIG. 20, FIG. 21, FIG. 22, FIG. 23, FIG. 24A, FIG. 24B, FIG. 25A, FIG. 25B, FIG. 26A, FIG. 26B, FIG. 26C, FIG. 26D, FIG. 26E, FIG. 27, and FIG. 28 are exemplary views for explaining a communication method of an electronic device according to various embodiments of the present invention.

### DETAILED DESCRIPTION

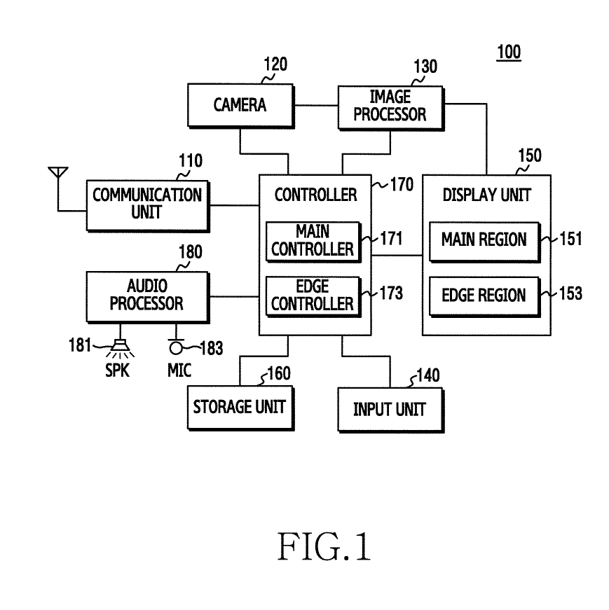

FIGS. 1 through 28, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device.

Exemplary embodiments of the present invention will be described herein below with reference to the accompanying drawings. In this case, it should be noted that like reference numerals denote like constitutional elements in the accompanying drawings. In the following description, well-known functions or constructions are not described in detail since they would obscure the invention in unnecessary detail.

In the following description, the term “edge communication” means a sensitivity data exchange between electronic devices. That is, each electronic device may generate and transmit sensitivity data, or may receive and output the sensitivity data. In this case, the sensitivity data may include an image, a drawing, an emoticon, and a poke. The image may include a still image and a moving image. Further, the term “poke” means sensitivity data for outputting an object in the electronic device. In this case, the sensitivity data may be generated by a sensitivity-based interaction between the electronic device and a user of the electronic device. Herein, the sensitivity data may include at least any one of time information and location information. For example, the object may include at least any one of a vibration, a sound, an animation, and a drawing.

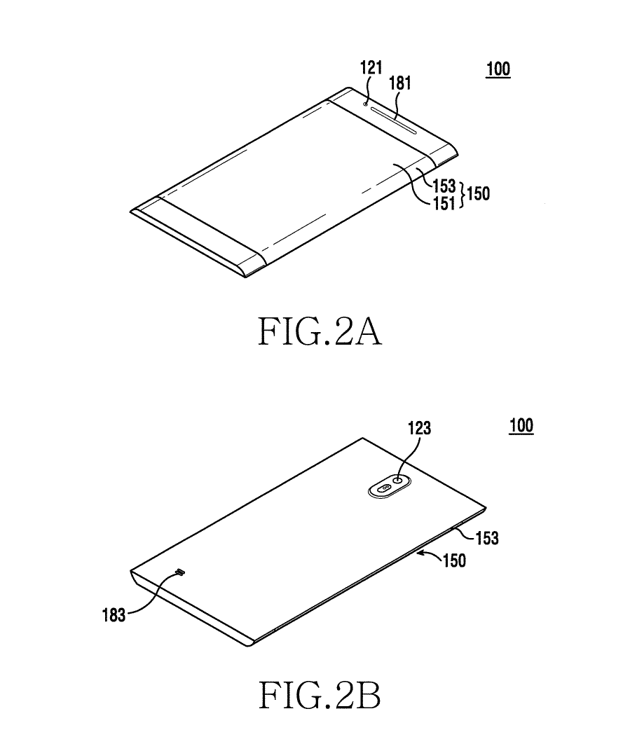

FIG. 1 is a block diagram illustrating an electronic device according to an exemplary embodiment of the present invention. In addition, FIGS. 2A and 2B are perspective views illustrating an example of implementing an electronic device according to an exemplary embodiment of the present invention. In this case, FIG. 2A is a plan perspective view of the electronic device, and FIG. 2B is a rear perspective view of the electronic device.

Referring to FIG. 1, an electronic device 100 of the present exemplary embodiment includes a communication unit 110, a camera 120, an image processor 130, an input unit 140, a display unit 150, a storage unit 160, a controller 170, and an audio processor 180.

The communication unit 110 performs communication in the electronic device 100. In this case, the communication unit 110 may communicate with an external device (not shown) by using various communication schemes. Herein, the communication unit 110 may perform at least any one of wireless communication and wired communication. For this, the communication unit 110 may access at least any one of a mobile communication network and a data communication network. Alternatively, the communication unit 110 may perform near distance communication. For example, the external electronic device may include an electronic device, a base station, a server, and a satellite. In addition, the communication scheme may include long term evolution (LTE), wideband code division multiple access (WDCMA), global system for mobile communications (GSM), wireless fidelity (WiFi), BLUETOOTH, and near field communications (NFC).

The camera 120 generates image data. For this, the camera 120 may receive an optical signal. In addition, the camera 120 may generate the image data from the optical signal. Herein, the camera 120 may include a camera sensor and a signal converter. The camera sensor may convert the optical signal into an electrical image signal. The signal converter may convert an analog image signal into digital image data.

In this case, as shown in FIGS. 2A and 2B, the camera 120 may include a front camera 121 and a rear camera 123. The front camera 121 may be disposed to a front portion of the electronic device 100. In addition, the front camera 121 may receive an optical signal from a front direction of the electronic device 100 to generate image data from the optical signal. The rear camera 123 may be disposed to a rear portion of the electronic device 100. In addition, the rear camera 123 may receive an optical signal from a rear direction of the electronic device 100 to generate image data from the optical signal.

The image processor 130 processes image data. In this case, the image processor 130 may process the image data in unit of frames to output the data in association with a feature and size of the display unit 150. Herein, the image processor 130 may compress the image data by using a determined method, or may restore the compressed image data into original image data.

The input unit 140 generates input data in the electronic device 100. In this case, the input unit 140 may generate the input data in response to a user input of the electronic device 100. In addition, the input unit 140 may include at least one input means. The input unit 140 may include a key pad, a dome switch, a physical button, a touch panel, a jog & shuttle, and a sensor.

The display unit 150 outputs display data. For example, the display unit 150 may include a liquid crystal display (LCD), a light emitting diode (LED) display, an organic light-emitting diode (OLED) display, a micro electro mechanical system (MEMS) display, and an electronic paper display. In addition, the display unit 150 may include a plurality of light emitting elements. In this case, the display unit 150 may be implemented as a touch screen by being coupled to the input unit 140.

In addition, the display unit 150 includes a main region 151 and an edge region 153. In this case, the main region 151 and the edge region 153 may output a display screen. That is, the display screen may be output by being divided into the main region 151 and the edge region 153. Alternatively, the main region 151 may output the display screen as a whole. Further, the edge region 153 may output color light. The main region 151 is disposed to the front portion of the electronic device 100. The edge region 153 is extended from an edge of the main region 151. That is, the edge region 153 may be extended from at least any one of an upper portion, lower portion, left portion, and right portion of the main region 151. Herein, the main region 151 and the edge region 153 may be formed in an integral manner.

For example, as shown in FIGS. 2A and 2B, the edge region 153 may be inclined from the main region 151. In other words, the edge region 153 may be extended from the main region 151 towards a rear portion of the electronic device 100. That is, the edge region 153 may be disposed to a lateral portion of the electronic device 100. Herein, the edge region 153 may be inclined to an outer portion of the main region 151. Accordingly, if the main region 151 is disposed to face an outer bottom portion, the color light of the edge region 153 may be exposed to the lateral portion of the electronic device 100, and may be reflected to the outer bottom portion. Alternatively, the edge region 153 may be inclined towards an inner portion of the main region 151. Accordingly, if the main region 151 is exposed to the outside, the color light of the edge region 153 may be exposed to the lateral portion of the electronic device 100, and may be reflected to the outer bottom portion.

Meanwhile, although not shown, the main region 151 and the edge region 153 may be formed as a flat surface. Herein, the main region 151 and the edge region 153 may be disposed to the same plane. Accordingly, the edge region 153 may be disposed to the front portion of the electronic device 100.

Meanwhile, although not shown, at least any one of the main region 151 and the edge region 153 may be formed as a curved surface. Herein, the main region 151 may be formed as a flat surface, and the edge region 153 may be formed as a curved surface. Alternatively, the main region 151 may be formed as a curved surface, and the edge region 153 may be formed as a flat surface. Alternatively, the main region 151 and the edge region 153 may be formed as a single curved surface. Alternatively, the main region 151 and the edge region 153 may be formed as mutually different curved surfaces.

For this, the display unit 150 may be manufactured to have flexibility and thereafter may be bent. In this case, the display unit 150 may be partially bent. Herein, as the display unit 150 is bent or curved, the edge region 153 may be inclined from the main region 151. More specifically, the display unit 150 may be curved or bent at a border portion of the main region 151 and the edge region 153. In addition, as at least any one of the main region 151 and the edge region 153 is curved, it may be formed in a curved surface. More specifically, any one of the main region 151 and the edge region 153 may be curved, and the main region 151 and the edge region 153 may be curved with mutually different curvatures. Alternatively, the display unit 150 may be bent as a whole. Herein, the main region 151 and the edge region 153 may be curved in an integral manner. In other words, the main region 151 and the edge region 153 may be curved with the same curvature.

The storage unit 160 may store operational programs of the electronic device 100. In this case, the storage unit 160 may store a program for controlling the main region 151 and the edge region 153 not only in an individual manner but also in an interrelated manner. In addition, the storage unit 160 may store a program for performing an edge communication function. Further, the storage unit 160 stores data generated while performing the programs.

The controller 170 controls an overall operation of the electronic device 100. In this case, the controller 170 may perform various functions. Herein, the controller 170 may perform the edge communication function. That is, the controller 170 may generate and transmit sensitivity data, or may receive and output the sensitivity data. For example, the sensitivity data may include an image, a drawing, an emoticon, and a poke. In addition, the controller 170 may control the display unit 150 to output display data. Herein, the controller 170 may control the main region 151 and the edge region 153 not only in an individual manner but also in an interrelated manner. Further, the controller 170 may detect input data through the input unit 140 in association with the main region 151 and the edge region 153. Herein, the controller 170 may detect a touch in the main region 151 and the edge region 153. Furthermore, the controller 170 includes a main controller 171 and an edge controller 173.

The main controller 171 controls the main region 151. In this case, the main controller 171 may activate the main region 151 to output a display screen. Herein, the display screen may include at least any one of an image and a text. In addition, the main controller 171 may display a screen of executing a function to the main region 151. Further, the main controller 171 may deactivate the main region 151.

The edge controller 173 controls the edge region 153. In this case, the edge controller 173 may output color light to the edge region 153. Herein, when a notification event occurs, the edge controller 173 may output color light in association with the notification event to the edge region 153. In addition, the edge controller 173 may change the color light in the edge region 153. Further, the edge controller 173 may control the edge region 153 by dividing it into a plurality of edge slots.

The audio processor 180 processes an audio signal. In this case, the audio processor 180 includes a speaker (SPK) 181 and a microphone (MIC) 183. That is, the audio processor 180 may reproduce the audio signal output from the controller 170 through the SPK 181. In addition, the audio processor 180 may deliver the audio signal generated from the MIC 183 to the controller 170.

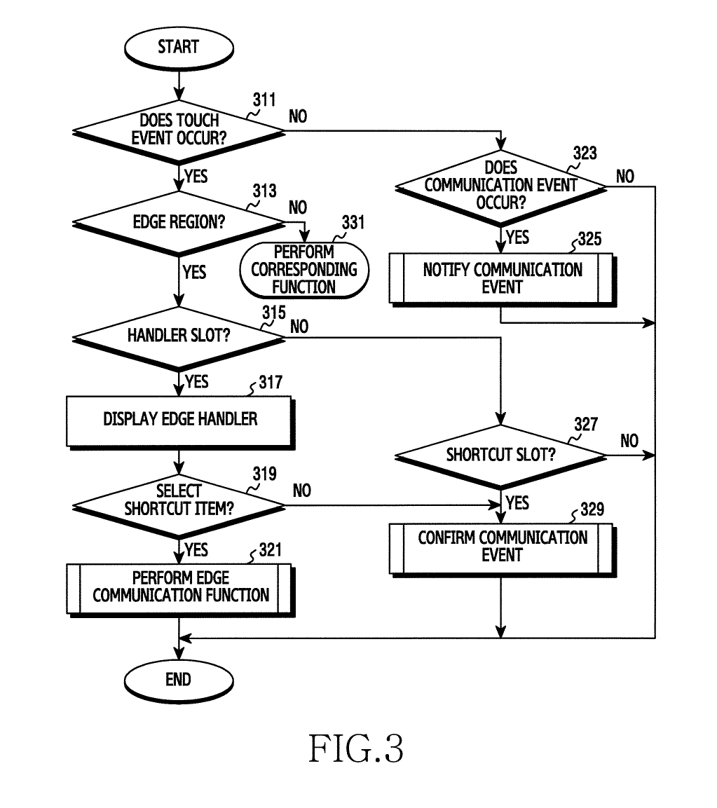

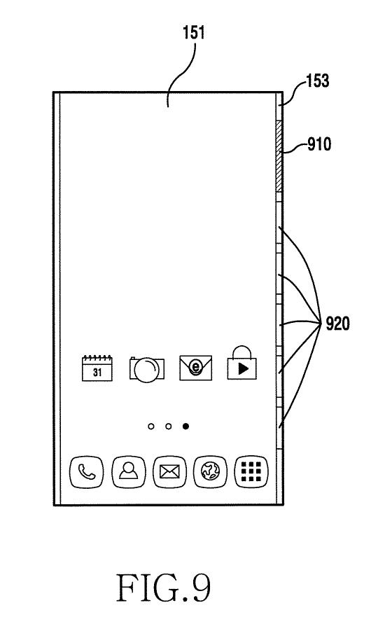

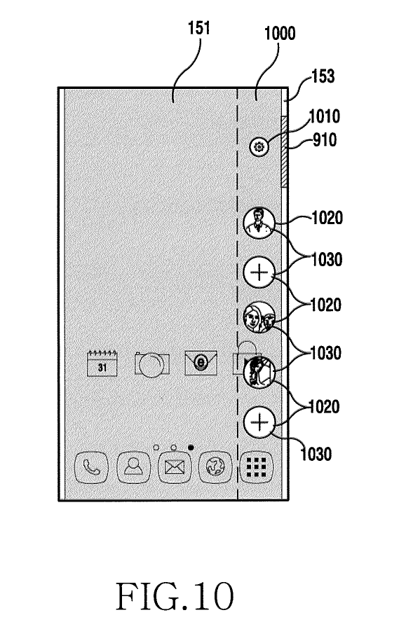

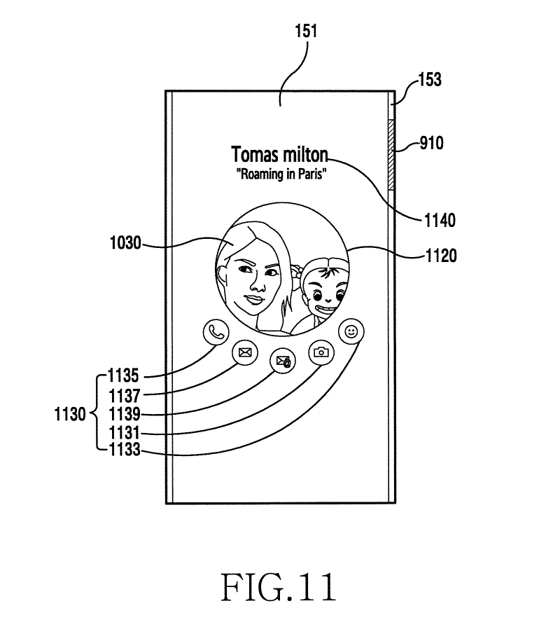

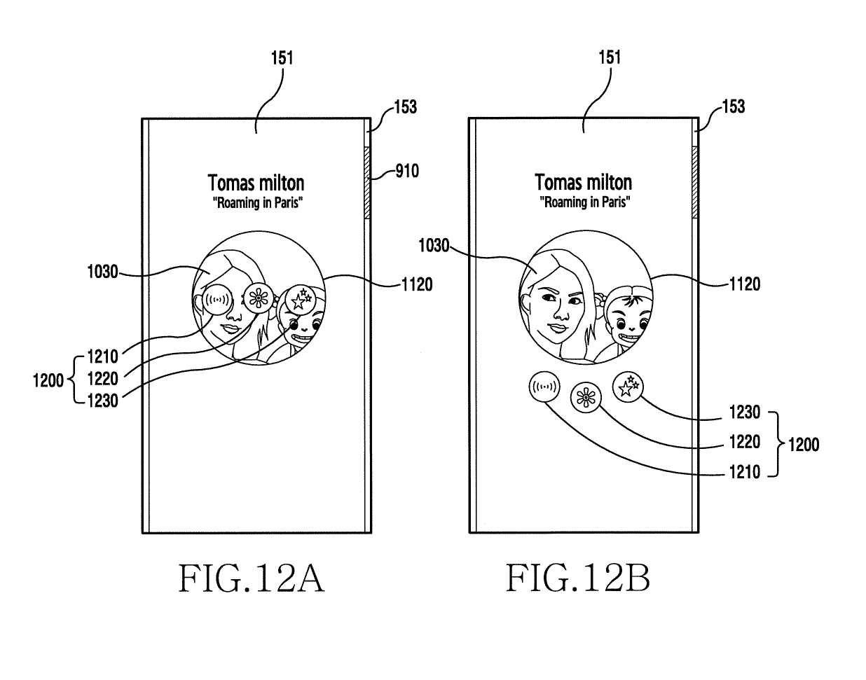

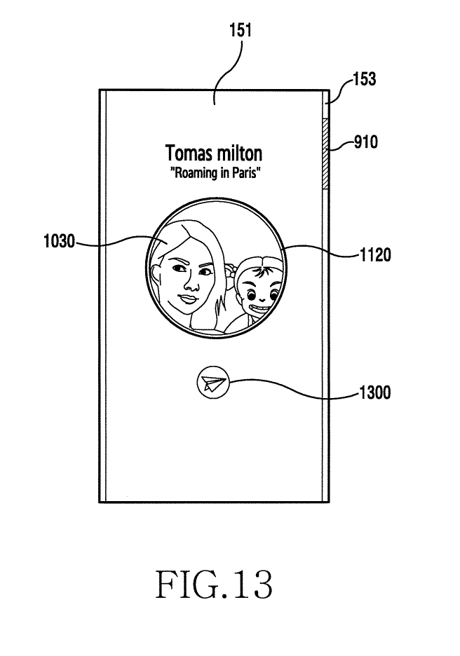

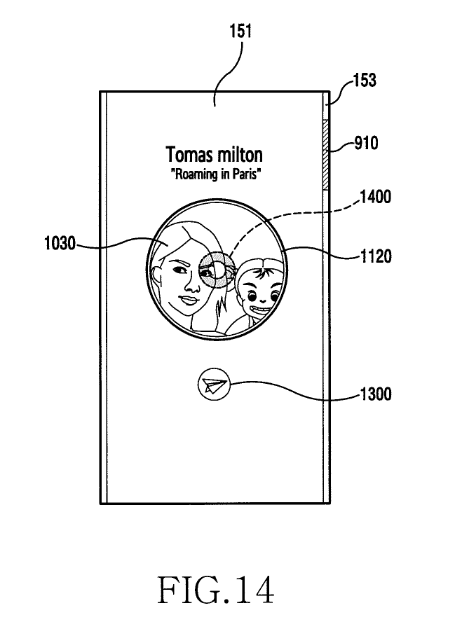

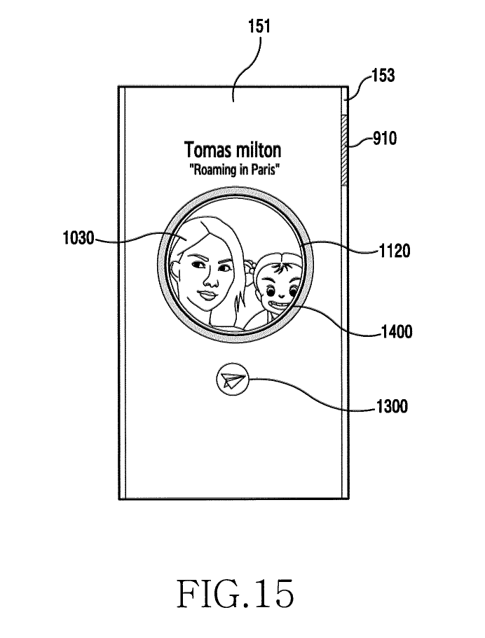

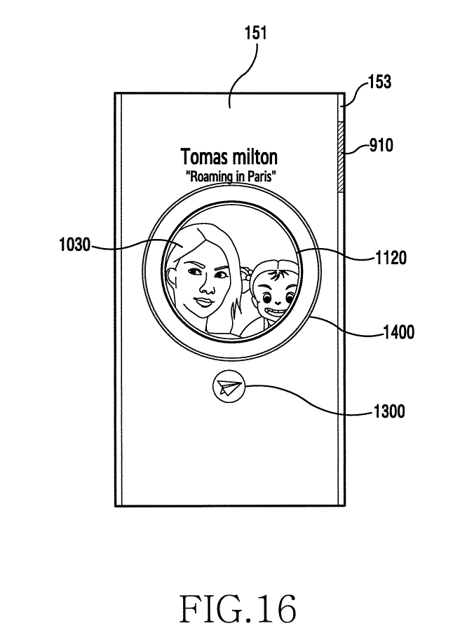

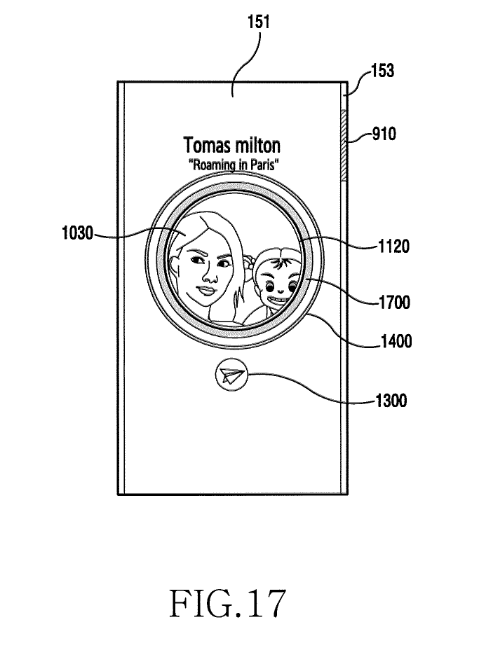

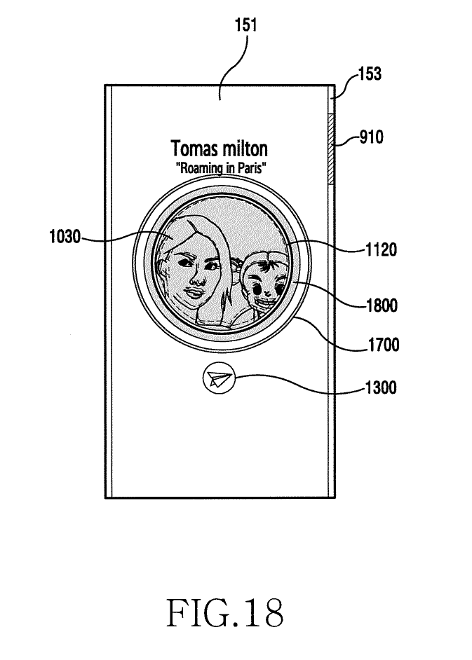

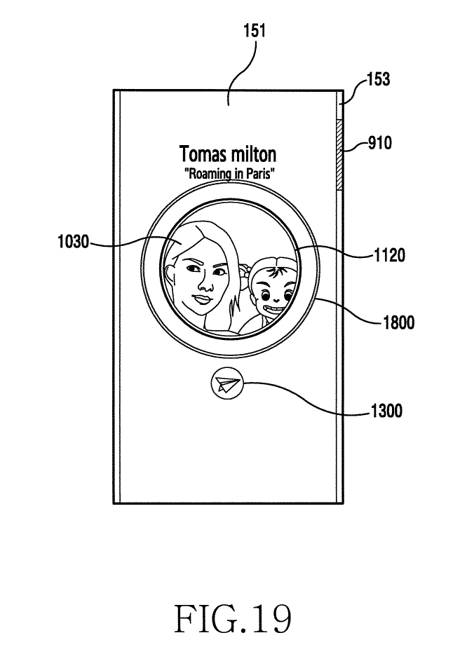

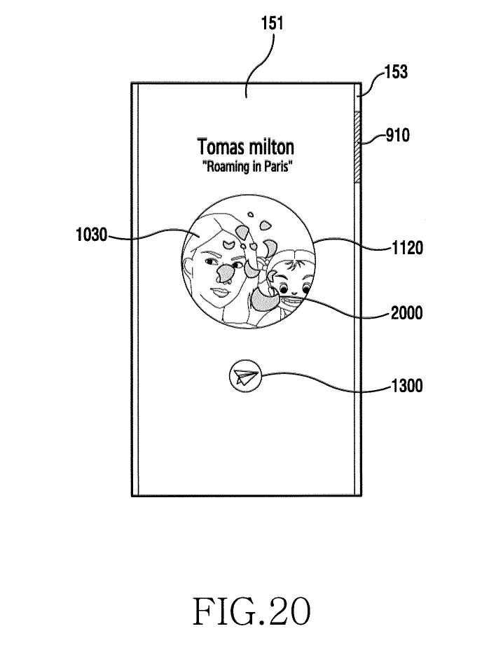

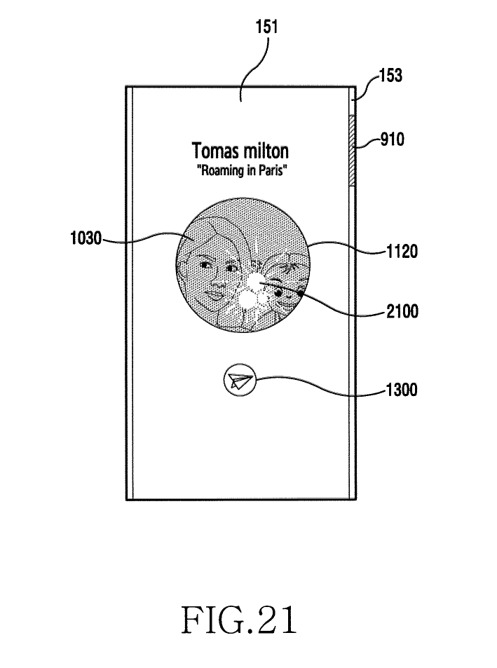

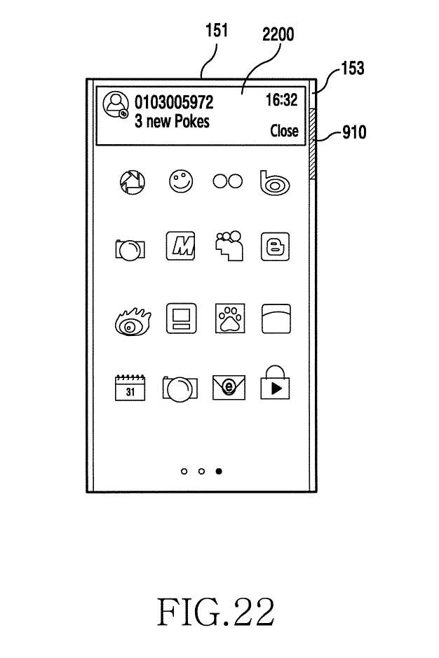

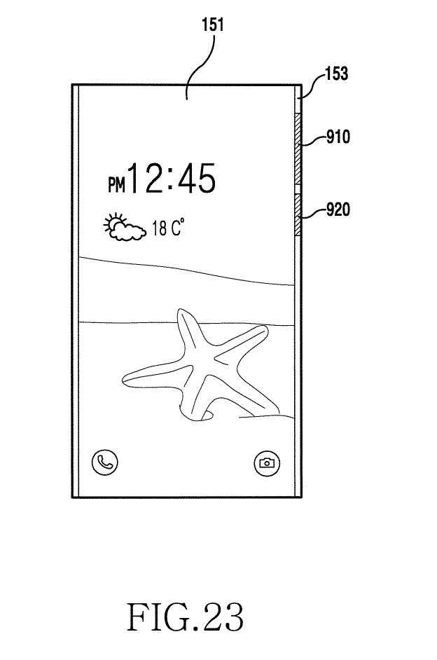

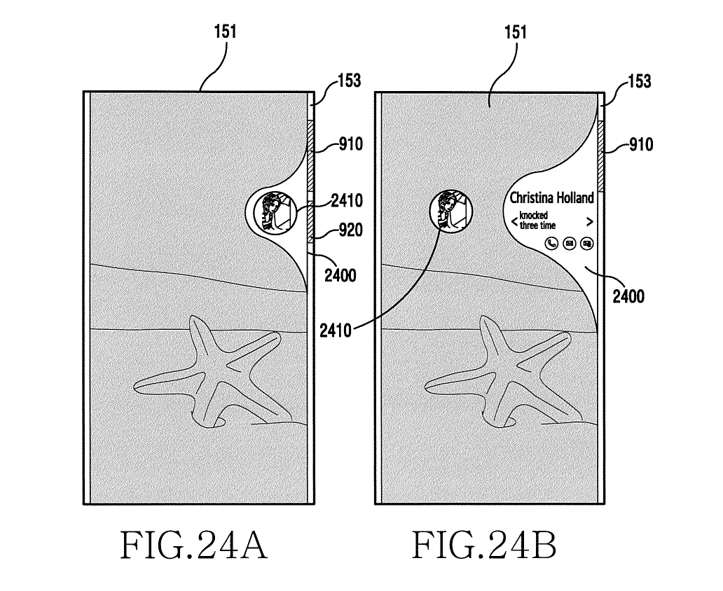

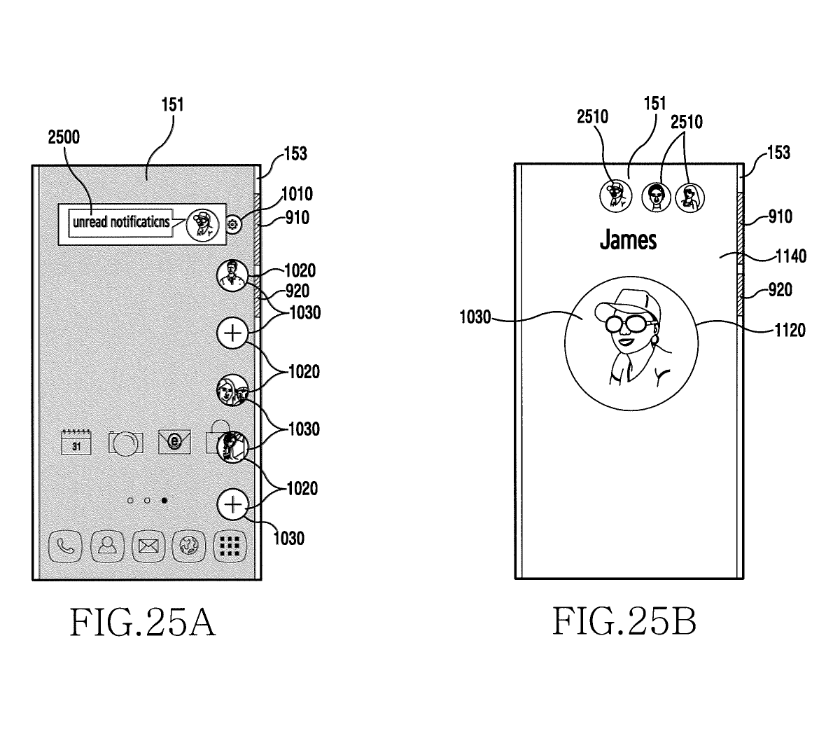

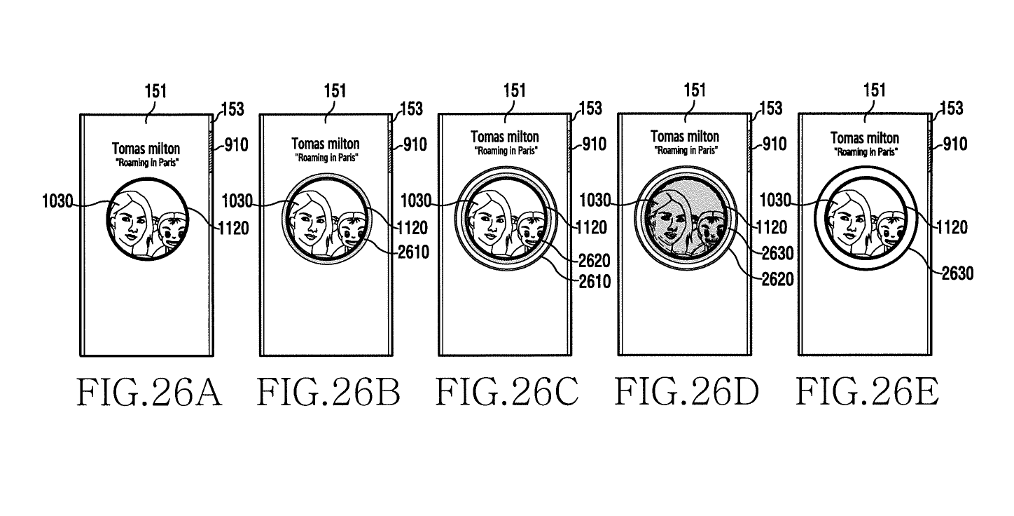

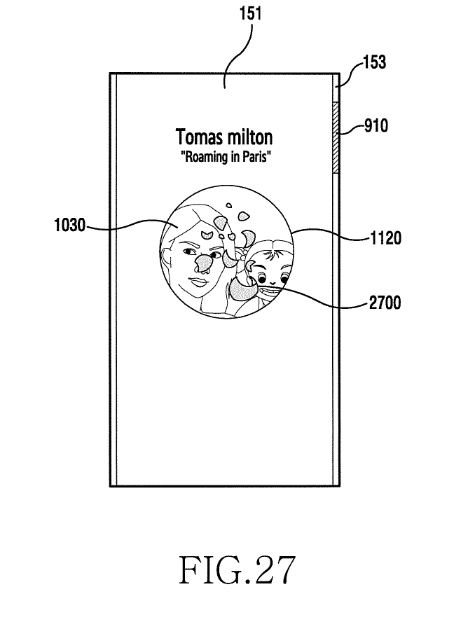

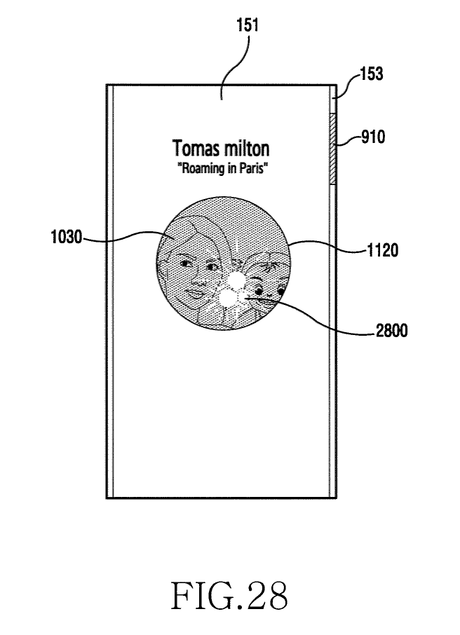

FIG. 3 is a flowchart illustrating a procedure of performing a communication method of an electronic device according to an exemplary embodiment of the present invention. FIG. 9, FIG. 10, FIG. 11, FIG. 12A, FIG. 12B, FIG. 13, FIG. 14, FIG. 15, FIG. 16, FIG. 17, FIG. 18, FIG. 19, FIG. 20, FIG. 21, FIG. 22, FIG. 23, FIG. 24A, FIG. 24B, FIG. 25A, FIG. 25B, FIG. 26A, FIG. 26B, FIG. 26C, FIG. 26D, FIG. 26E, FIG. 27, and FIG. 28 are exemplary views for explaining a communication method of an electronic device according to an exemplary embodiment of the present invention.

Referring to FIG. 3, a procedure of performing a communication method of the electronic device 100 according to an exemplary embodiment of the present invention begins with detecting of a touch event by the controller 170 in operation 311. That is, when the touch event occurs through the input unit 140, the controller 170 may detect this. Herein, the input unit 140 may detect a touch of a user of the electronic device 100 to generate the touch event. For example, the input unit 140 may detect a touch, a release of the touch, and a movement of the touch.

In this case, the controller 170 may detect a touch location in association with the touch event. Herein, the controller 170 may detect the touch location as a coordinate value. For example, the controller 170 may detect the touch location as a positive (+) coordinate value in the main region 151, and may detect the touch location as a negative (−) coordinate value in the edge region 153. In addition, the controller 170 may detect a plurality of coordinate values in a touch area, and may select any one of the coordinate values and determine it as the touch location. Further, the controller 170 may detect a detection time of the touch location. For example, when one touch event occurs, the controller 170 may detect this as a tap. Alternatively, when a plurality of touch events occur continuously, the controller 170 may detect this as a touch gesture such as a multi-tap, a hold, a drag, a flick, a move, or the like.

Next, in operation 313, the controller 170 may determine whether the touch event occurs from the edge region 153. That is, the controller 170 determines whether the touch location of the touch event corresponds to the edge region 153. Herein, the controller 170 may determine whether an initial touch location of the touch event corresponds to the edge region 153. In addition, the controller 170 may determine whether the touch event is associated with a movement of a touch from the edge region 153 to the main region 151.

For example, as shown in FIG. 9, the edge region 153 may include a plurality of edge slots 910 and 920. The edge slots 910 and 920 may be arranged by being separated from each other in the edge region 153. That is, the edge slots 910 and 920 may be disposed respectively to different locations in the edge region 153. In addition, different colors may be respectively allocated to the edge slots 910 and 920. The edge slots 910 and 920 may include a handler slot 910 and at least one shortcut slot 920.

Next, if it is determined in operation 313 that the touch event occurs from the edge region 153, the controller 170 may determine whether the touch event corresponds to the handler slot 910 in operation 315. Herein, the controller 170 may determine whether the initial touch location of the touch event corresponds to the handler slot 810. In addition, the controller 170 may determine whether the touch event is association with a movement of a touch from the handler slot 910 to the main region 151.

Next, if it is determined in operation 315 that the touch event is association with the handler slot 910, the controller 170 may display an edge handler 1000 to the main region 151 in operation 317. For example, the controller 170 may display the edge handler 1000 in the main region 151 at a location adjacent to the edge region 153 as shown in FIG. 10. That is, the controller 170 may display the edge handler 1000 in parallel to the edge region 153.

In this case, the edge handler 1000 may include a plurality of edge items 1010 and 1020. The edge items 1010 and 1020 may be arranged by being separated from the edge handler 1000. That is, the edge items 1010 and 1020 may be disposed respectively to different locations in the edge handlers 1000. For example, the edge items 1010 and 1020 may have a circular shape, and may also have a polygonal shape. The edge items 1010 and 1020 may include a setup item 1010 and at least one shortcut item 1020.

Herein, the shortcut item 1020 may be associated with the shortcut slot 920. In addition, the shortcut item 1020 may be associated with pre-set identification data. For example, the identification data may be used to have access to an external device. Further, the shortcut item 1020 may be formed as a pre-set identification image 1030 in association with the identification data. For example, a profile image may be pre-set in association with the identification data, and the identification image 1030 may be formed as at least one part of the profile image. That is, the controller 170 may generate the shortcut item 1020 by decreasing a size of the identification image 1030 to a pre-set size.

Finally, when the shortcut item 1020 is selected in the edge handler 1000, the controller 170 may detect this in operation 319. In addition, the controller 170 may perform an edge communication function by using the identification data of the shortcut item 1020 in operation 321. For example, the controller 170 may perform the edge communication function as shown in FIG. 11, FIG. 12A, FIG. 12B, FIG. 13, FIG. 14, FIG. 15, FIG. 16, FIG. 17, FIG. 18, FIG. 19, FIG. 20, and FIG. 21. In this case, the controller 170 may acquire an edge image and transmit it through the camera 120. Alternatively, the controller 170 may generate a drawing and transmit it. Alternatively, the controller 170 may add the drawing to the edge image and transmit it. Alternatively, the controller 170 may select an emoticon and transmit it. Alternatively, the controller 170 may generate sensitivity data and transmit it. Herein, the sensitivity data may include at least any one of time information and location information. For example, an object may include at least any one of a vibration, a sound, an image, an animation, and a drawing. Accordingly, the procedure of performing the communication method of the electronic device 100 according to the exemplary embodiment of the present invention may end.

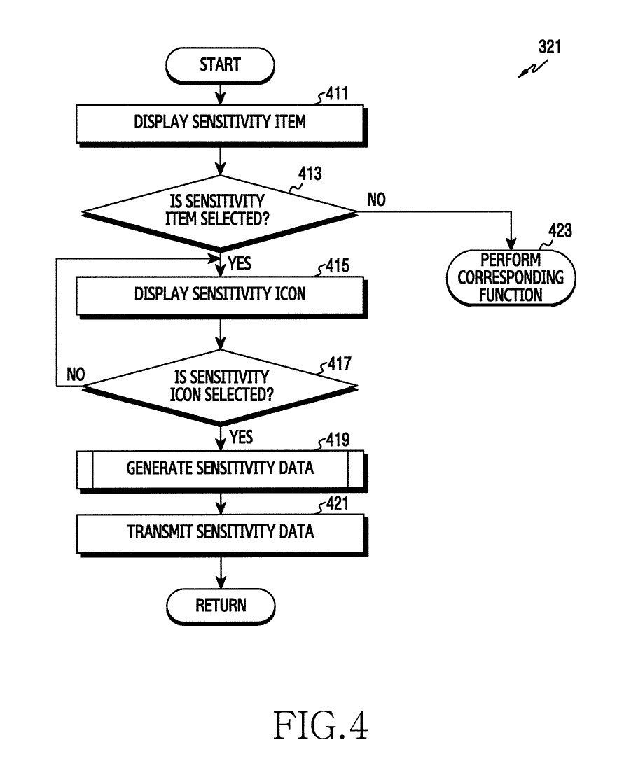

FIG. 4 is a flowchart illustrating a procedure of performing an edge communication function execution operation of FIG. 3.

Referring to FIG. 4, in the procedure of performing the edge communication function execution operation in the present exemplary embodiment, the controller 170 displays a sensitivity item 1120 in operation 411. In addition thereto, the controller 170 may further display a communication icon 1130. For example, the controller 170 may display the sensitivity item 1120 and the communication icon 1130 in the main area 151 as shown in FIG. 11. That is, the controller 170 may display the communication icon 1130 around the sensitivity item 1120 in the main area 151.

In this case, the sensitivity item 1120 may be formed as a pre-set identification image 1030 in association with a shortcut item 1020. That is, the controller 170 may generate the sensitivity item 1120 by shrinking the identification image 1030 to a pre-set size. Herein, the controller 170 may display the sensitivity item 1120 by enlarging the shortcut item 1020 in the main area 151. That is, the controller 170 may display the sensitivity item 1120 by enlarging the shortcut item 1020 to a pre-set size. For this, the controller 170 may move the shortcut item 1020 in the main area 151. For example, a shape of the shortcut item 1020 may be identical to a shape of the sensitivity item 1120. In addition, a size of the sensitivity item 1120 may exceed a size of the shortcut item 1020. Further, the sensitivity item 1120 and the shortcut item 1020 may be generated from the same identification image 1030.

Further, the identification image 1030 includes a camera icon 1131 for driving the camera 120. Additionally, the communication icon 1130 may further include at least any one of an emoticon icon for selecting an emoticon, a call icon 1135 for originating a call, a short message icon 1137 for writing a short message, and a multimedia message icon 1139 for writing a multimedia message. In addition thereto, the controller 170 may further display a state message 1140 by being separated from the sensitivity item 1120 in the main area 151. The state message 1140 may be registered by a user of the electronic device 100 or a user of an external device in response to identification data.

Subsequently, when the sensitivity item 1120 is selected, the controller 170 detects this in operation 413. Further, the controller 170 displays a sensitivity icon 1200 in operation 415. In this case, the controller 170 may deactivate the sensitivity item 1120 in the main area 151. That is, the controller 170 may deactivate the sensitivity item 1120 while continuously displaying the shortcut item 1020 in the main area 151. For example, the controller 170 may display the sensitivity icon 1200 to the sensitivity item 1120 in the main area 151 as shown in FIG. 12A. Alternatively, the controller 170 may display the sensitivity icon 1200 around the sensitivity item 1120 in the main area 151 as shown in FIG. 12B. For this, the controller 170 may remove the communication icon 1130 in the main area 151.

In this case, the sensitivity icon 1200 may be offered to determine an object for expressing a sensitivity of the user of the electronic device 400. Herein, the object may include at least any one of a vibration, a sound, an image, an animation, and a drawing. For example, the object may include at least any one of a radio wave and a particle. In addition, the particle may include at least any one of a petal and a light emitting particle. For example, the sensitivity icon 1200 may include at least any one of a knock icon 1210 for generating a radio wave, a petal icon 1220 for generating a petal, and a twinkle icon 1230 for generating a light emitting particle.

Subsequently, when the sensitivity item 1120 is selected, the controller 170 detects this in operation 417. In addition, the controller 170 generates sensitivity data in operation 419. The controller 170 may record the sensitivity data during a pre-set time. In this case, the controller 170 may detect a touch event from the identification image 1030. Further, the controller 170 may record the sensitivity data on the basis of the touch event. Furthermore, the controller 170 may record the sensitivity data as a text. Herein, the sensitivity data may include at least any one of time information and location information. For example, the time information of the sensitivity data may be determined as a detection time of the touch event, and the location information of the sensitivity data may be determined as a touch location of the touch event. For example, the controller 170 may generate the sensitivity data as shown in FIG. 13, FIG. 14, FIG. 15, FIG. 16, FIG. 17, FIG. 18, FIG. 10, FIG. 20, and FIG. 21. That is, the controller 170 may generate the sensitivity data in association with any one of the radial wave, the petal, and the light emitting particle.

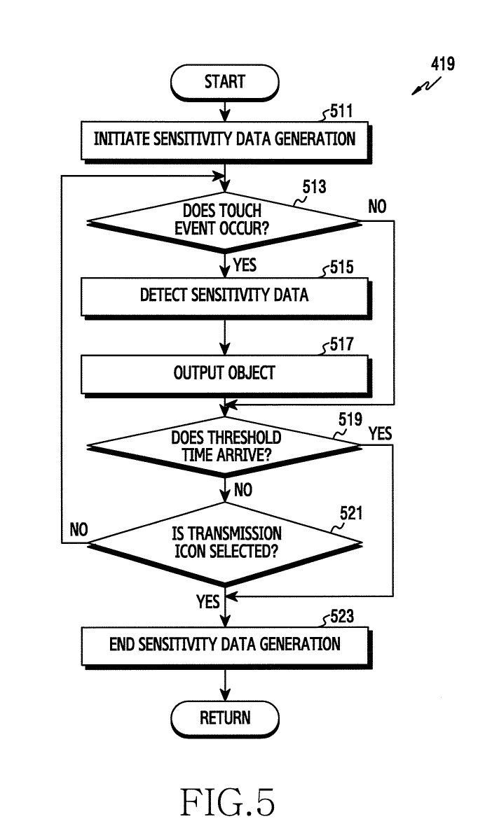

FIG. 5 is a flowchart illustrating a procedure of performing a sensitivity data generation operation of FIG. 4.

Referring to FIG. 5, the procedure of performing the sensitivity data generation operation in the present exemplary embodiment begins with initiating of the sensitivity data generation operation performed by the controller 170 in operation 511. In this case, the controller 170 may activate the sensitivity item 1120 in the main area 151. For example, the controller 170 may activate the sensitivity item 1120 in the main area 151 as shown in FIG. 13. In addition thereto, the controller 170 may further display a transmission icon 1300 for transmitting the sensitivity data.

Next, when a touch event occurs, the controller 170 detects this in operation 513. In this case, when the touch event occurs in association with the sensitivity item 1120, the controller 170 may detect this. In addition, the controller 170 detects the sensitivity data in operation 515. In this case, the controller 170 may detect at least any one of a touch location and a detection time of the touch location in association with the touch event. More specifically, the controller 170 may detect the touch location in association with the touch event. Herein, the controller 170 may detect the touch location as a coordinate value. Further, the controller 170 may detect a detection time of the touch location. For example, when one touch event occurs, the controller 170 may detect this as a tap. Alternatively, when a plurality of touch events occur continuously, the controller 170 may detect this as a touch gesture such as a multi-tap, a drag, a flick, a move, or the like. Further, the controller 170 may record at least any one of the touch location and the detection time of the touch location as the sensitivity data. Herein, the controller 170 may record the sensitivity data as a text.

Next, the controller 170 outputs an object from the identification image 1030 in operation 517. In this case, the controller 170 outputs the object from the identification image 1030 on the basis of the touch event. That is, the controller 170 outputs the object from the identification image 1030 according to the sensitivity data. Herein, the controller 170 may output the object from the identification image 1030 in response to the detection time of the touch location. Alternatively, the controller 170 may output the object from the identification image 1030 in association with a coordinate value of the touch location. In addition, the object may include at least any one of a vibration, a sound, an image, an animation, and a drawing. For example, the object may include at least any one of a radio wave and a particle. Further, the particle may include at least any one of a petal and a light emitting particle.

For example, when the knock icon 1210 is selected in operation 417, in association with a touch event such as a tap, the controller 170 may record a detection time of the tap. Further, the controller 170 may generate a radial wave 1400 from the identification image 1030 in association with the touch event such as the tap as shown in FIG. 14, FIG. 15, FIG. 16, FIG. 17, FIG. 18, and FIG. 19.

More specifically, in association with the tap, the controller 170 may generate the radial wave 1400 in a background of the identification image 1030 as shown in FIG. 14. Further, the controller 170 may move the radial wave 1400 to an outer portion of the identification image 1030 as shown in FIG. 15 and FIG. 16. In this manner, the controller 170 may extinguish the radial wave 1400 from the identification image 1030.

Herein, when the radial wave 1400 is generated, an internal diameter of the radial wave 1400 may correspond to 10% of the identification image 1030, and an external diameter of the radial wave 1400 may correspond to 20% of the identification image 1030. In addition, when approximately 400 ms elapses from the detection time of the tap, the internal diameter of the radial wave 1400 may correspond to 40% of the identification image 1030, and the external diameter of the radial wave 1400 may correspond to 76% of the identification image 1030. Further, when approximately 800 ms elapses from the detection time of the tap, the internal diameter of the radial wave 1400 may correspond to 100% of the identification image 1030, and the outer diameter of the radial wave may correspond to 115% of the identification image 1030. Furthermore, when approximately 1200 ms elapses from the detection time of the tap, the internal diameter of the radial wave 1400 may correspond to 135% of the identification image 1030, and the outer diameter of the radial wave may correspond to 135% of the identification image 1030. Thereafter, the radial wave 1400 may be extinguished.

Meanwhile, when a plurality of taps is generated within a pre-set time interval, the controller 170 may record detection times of the taps. Further, the controller 170 may continuously generate radial waves 1400, 1700, and 1800 in association with the taps. That is, the controller 170 may generate the radial waves 1400, 1700, and 1800 in association with the respective taps. In addition, the controller 170 may display the radial waves 1400, 1700, and 1800 in association with the identification image 1030 as shown in FIG. 15, FIG. 17, FIG. 18, and FIG. 19. Further, the controller 170 may continuously move the radial waves 1400, 1700, and 1800 to an outer portion of the identification image 1030. In this manner, the controller 170 may sequentially extinguish the radial waves 1400, 1700, and 1800 from the identification image 1030.

Herein, according to a time difference between the detection times and an order of the detection times, the controller 170 may determine colors of the radial waves 1400, 1700, and 1800. That is, on the basis of the time difference between the detection times and the order of the detection times, the controller 170 may change at least any one of hue, saturation, or brightness of the radial waves 1400, 1700, and 1800. Alternatively, according to the time difference between the detection times and the order of the detection times, the controller 170 may add a color to the identification image 1030. That is, on the basis of the time difference of the detection times and the order of the detection times, the controller 170 may change at least any one of hue, saturation, and brightness of the identification image 1030. Alternatively, according to the time difference of the detection times and the order of the detection times, the controller 170 may vibrate the identification image 1030 within a pre-set range. That is, on the basis of the time difference between the detection times and the order of the detection times, the controller 170 may change a vibration range of the identification image 1030. For example, if the number of taps exceeds a pre-set number, the controller 170 may change at least any one of hue, saturation, and brightness of the identification image 1030 as shown in FIG. 18. Alternatively, if the number of taps exceeds the pre-set number, the controller 170 may change the vibration range of the identification image 1030 as shown in FIG. 18.

Alternatively, when the petal icon 1220 is selected in operation 417, the controller 170 may record a coordinate value of at least one touch location in association with a touch event such as a touch gesture. Further, the controller 170 may generate a petal 2000 from the identification image 1030 in association with the touch event such as the touch gesture as shown in FIG. 20. More specifically, the controller 170 may generate the petal 2000 from the identification image 1030 in association with the touch gesture. That is, the controller 170 may allow the petal 2000 to come out from a touch location of the identification image 1030. Herein, the controller 170 may allow the petal 2000 to continuously come out along a movement path of the touch.

Alternatively, when the twinkle icon 1230 is selected in operation 419, the controller 170 may record a coordinate value of at least one touch location in association with a touch event such as a touch gesture. Further, the controller 170 may generate a light emitting particle 2100 from the identification image 1030 in association with the touch event such as the touch gesture as shown in FIG. 21. More specifically, the controller 170 may allow the light emitting particle 2100 to come out from the identification image 1030 in association with the touch gesture. Herein, the controller 170 may allow the light emitting particle 2100 to continuously come out along the movement path of the touch.

Next, the controller 170 determines whether a threshold time arrives in operation 519. That is, the controller 170 determines whether the threshold time elapses from a time of initiating the sensitivity data generation operation. In this case, the controller 170 may determine whether activation of the sensitivity item 1120 is maintained during the threshold time.

Next, if it is determined in operation 519 that the threshold time arrives, the controller 170 ends the sensitivity data generation operation in operation 523. In this case, the controller 170 may deactivate the sensitivity item 1120 in the main area 151. Thereafter, the controller 170 may end the procedure of performing the sensitivity data generation operation, and then may return to FIG. 4.

Meanwhile, if it is determined in operation 519 that the threshold time does not arrive and the transmission icon 1300 is selected, the controller 170 detects this in operation 521. Further, the controller 170 ends the sensitivity data generation operation in operation 523. In this case, the controller 170 may deactivate the sensitivity item 1120 in the main area 151. Thereafter, the controller 170 may end the procedure of performing the sensitivity data generation operation, and then may return to FIG. 4.

Meanwhile, if it is determined in operation 519 that the threshold time does not arrive and the transmission icon 1300 is not selected in operation 521, the controller 170 may return to the operation 513. Further, the controller 170 may perform at least a part of the operations 513 to 523. Thereafter, the controller 170 may end the procedure of performing the sensitivity data generation operation, and may return to FIG. 4.

Finally, the controller 170 transmits the sensitivity data in operation 421. Herein, the controller 170 may transmit the sensitivity data by using the identification data of the shortcut item 1020. In this case, the controller 170 may transmit the sensitivity data as a text. Herein, the sensitivity data may include at least any one of time information and location information. For example, if the sensitivity data is associated with a radial wave, the controller 170 may transmit the sensitivity data as shown in Table 1 below. Herein, the controller 170 may transmit a detection time of a touch location as a text. Meanwhile, if the sensitivity data is associated with a petal, the controller 170 may transmit the sensitivity data as shown in Table 2 below. Alternatively, if the sensitivity data is associated with a light emitting particle, the controller 170 may transmit the sensitivity data as shown in Table 3 below. Herein, the controller 170 may transmit a coordinate value of the touch location as a text. Thereafter, the controller 170 may end the procedure of performing the edge communication function execution operation, and may return to FIG. 3.

TABLE 1

[{
“id”: 168340234,
“Knock_Signal”: ”0, 10, 100, 150, 200, 300”
}]

TABLE 2

[{
“id” : 168340234,
“Petal_SignalX”: “0, 46, 140, 30, 200, 300”
“Petal_SignalY”: “0, 10, 100, 150, 220, 500”
}]

TABLE 3

[{
“id” : 168340234,
“Twink_SignalX”: “0, 46, 140, 30, 200, 300”
“Twink_SignalY”: “0, 10, 100, 150, 220, 500”
}]

Meanwhile, if the sensitivity item 1120 is not selected in operation 413, the controller 170 performs a corresponding function in operation 423. In this case, if a camera icon 1031 is selected, the controller 170 may acquire an edge image through the camera 120, and may transmit it by using identification data of the shortcut slot 920. Alternatively, if the camera icon 1031 is selected, the controller 170 may generate a drawing, and may transmit it by using the identification data of the shortcut slot 920. Alternatively, if the camera icon 1031 is selected, the controller 170 may add a drawing to the edge image, and may transmit it by using the identification data of the shortcut slot 920. Alternatively, if an emoticon icon 1033 is selected, the controller 170 may select an emoticon, and may transmit it by using the identification data of the shortcut slot 920. Alternatively, if a call icon 1035 is selected, the controller 170 may originate a call by using the identification data of the shortcut slot 920. Alternatively, if a short message icon 1037 is selected, the controller 170 may write a short message, and may transmit the short message by using the identification data of the shortcut slot 920. Alternatively, if a multimedia icon 1039 is selected, the controller 170 may write a multimedia message, and may transmit the multimedia message by using the identification data of the shortcut slot 920. Thereafter, the controller 170 may end the procedure of the operation for performing an edge communication function, and may return to FIG. 3.

Meanwhile, if the communication event occurs instead of the touch event in operation 311, the controller 170 detects this in operation 323. That is, if the communication event occurs through the communication unit 110, the controller 170 may detect this. In this case, if the communication occurs according to the edge communication function, the controller 170 may detect this. Herein, the communication unit 110 may generate the communication event by receiving a radio signal from an external device. Further, the controller 170 may notify the communication event in operation 325. For example, the controller 170 may notify the communication event as shown in FIG. 22, FIG. 23, FIG. 26A, FIG. 26B, FIG. 26C, FIG. 26D, FIG. 26E, FIG. 27, and FIG. 28. In this case, the controller 170 may receive an edge image from the external device. Alternatively, the controller 170 may receive a drawing from the external device. Alternatively, the controller 170 may receive the drawing together with the edge image from the external device. Alternatively, the controller 170 may receive an emoticon from the external device. Alternatively, the controller 170 may receive sensitivity data from the external device. The controller 170 may receive the sensitivity data as a text. Herein, the sensitivity data may include at least any one of time information and location information. For this, the procedure of performing the communication method of the electronic device 100 according to the exemplary embodiment of the present invention may end.

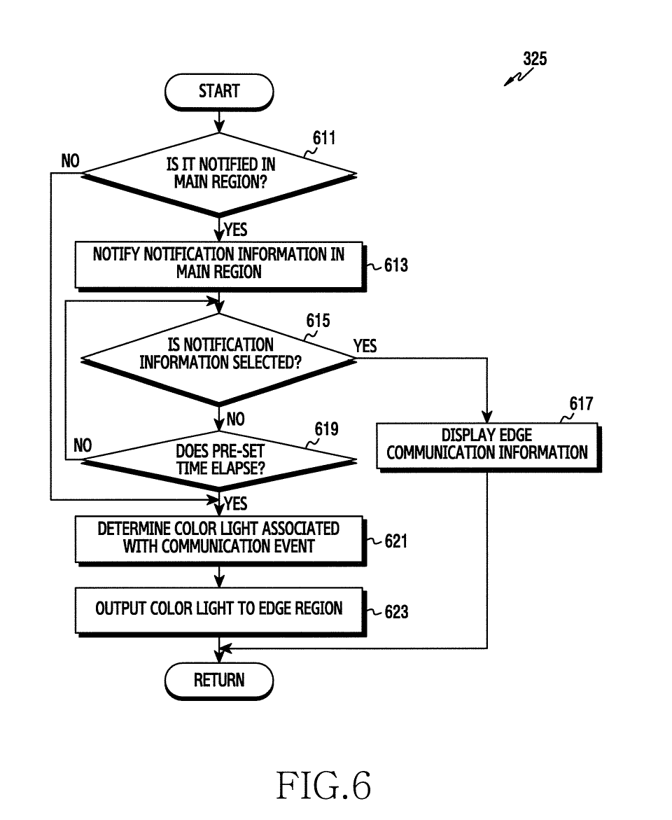

FIG. 6 is a flowchart illustrating a procedure of performing a communication event notification operation of FIG. 3.

Referring to FIG. 6, the procedure of performing the communication event notification operation of the present exemplary embodiment determines whether the controller 170 will notify a communication event in the main area 151 in operation 611. In this case, the controller 170 may determine whether it is pre-set in the main area 151 to notify the communication event. Alternatively, the controller 170 may determine whether the display 150 is activated.

Next, if it is determined in operation 611 that the communication event needs to be notified in the main area 151, the controller 170 notifies the communication event in the main area 151 in operation 613. That is, the controller 170 notifies notification information of the communication event in the main area 151. For example, the controller 170 may display a main notification window 2200 in the main area 151 as shown in FIG. 22. Further, the controller 170 may display the notification information to the main notification window 2200.

Next, if the notification information is selected, the controller 170 detects this in operation 615. Herein, if the notification information is selected in the main notification window 2200, the controller 170 may detect this. Further, the controller 170 may display edge communication information in operation 617. In this case, the edge communication information may indicate specific information of the communication event. Further, the edge communication information may include sensitivity data. Herein, the sensitivity data may include at least any one of time information and location information. Herein, the controller 170 may detect at least any one of the time information and the location information by analyzing the sensitivity data. For example, the controller 170 may determine the time information of the sensitivity data as an output time of an object, and may determine the location information of the sensitivity data as an output location of the object. Further, the object may include at least any one of a vibration, a sound, an image, an animation, and a drawing. For example, the object may include at least any one of a radio wave and a particle. Furthermore, the particle may include at least any one of a petal and a light emitting particle. Thereafter, the controller 170 may end the procedure of performing the communication event notification operation, and may return to FIG. 3.

For example, the controller 170 may detect an output time of at least one of radial waves 2610, 2620, and 2630 from the sensitivity data. In addition, the controller 170 may display the identification image of the external device as shown in FIG. 26A. Further, the controller 170 may generate the radial waves 2610, 2620, and 2630 in the identification image 1030 at the output time as shown in FIGS. 26B, 26C, 26D, and 26E, and may move the radial waves to an outer portion of the identification image 1030. Accordingly, the controller 170 may extinguish the radial waves 2610, 2620, and 2630 from the identification image 1030.

Meanwhile, the controller 170 may continuously generate the plurality of radial waves 2610, 2620, and 2630. That is, the controller 170 may generate the radial waves 2610, 2620, and 2630 at respective output times. In addition, the controller 170 may display the radio waves 2610, 2620, and 2630 in association with the identification image 1030. Further, the controller 170 may move the radial waves 2610, 2620, and 2630 continuously to an outer portion of the identification image 1030. Accordingly, the controller 170 may sequentially extinguish the radial waves 2610, 2620, and 2630 from the identification image 1030.

Herein, according to a time difference between the detection times and an order of the detection times, the controller 170 may determine colors of the radial waves 2610, 2620, and 2630. That is, on the basis of the time difference between the detection times and the order of the detection times, the controller 170 may change at least any one of hue, saturation, or brightness of the radial waves 2610, 2620, and 2630. Alternatively, according to the time difference between the detection times and the order of the detection times, the controller 170 may add a color to the identification image 1030. That is, on the basis of the time difference of the detection times and the order of the detection times, the controller 170 may change at least any one of hue, saturation, and brightness of the identification image 1030. Alternatively, according to the time difference of the detection times and the order of the detection times, the controller 170 may vibrate the identification image 1030 within a pre-set range. That is, on the basis of the time difference between the detection times and the order of the detection times, the controller 170 may change a vibration range of the identification image 1030. For example, the controller 170 may change at least any one of hue, saturation, and brightness of the identification image 1030 as shown in FIG. 26D. Alternatively, the controller 170 may change the vibration range of the identification image 1030 as shown in FIG. 26D.

Alternatively, the controller 170 may detect an output location of at least one petal 2700 from the sensitivity data. In addition, the controller 170 may generate the petal 2700 from the identification image 1030 of the external device as shown in FIG. 27. More specifically, the controller 170 may allow the petal 2700 to come out from the output location of the identification image 1030. Herein, the controller 170 may allow the petal 2700 to continuously come out along a movement path based on the output location.

Alternatively, the controller 170 may detect the output location of at least one light emitting particle 2800 from the sensitivity data. In addition, the controller 170 may generate the light emitting particle 2800 from the identification image 1030 of the external device as shown in FIG. 28. More specifically, the controller 170 may allow the light emitting particle 2800 to come out from the output location of the identification image 1030. Herein, the controller 170 may allow the light emitting particle 2800 to continuously come out along a movement path based on the output location.

Meanwhile, if notification information is not selected in operation 615 but a pre-set time elapses, the controller 170 detects this in operation 619. In addition, the controller 170 determines color light in association with a communication event in operation 621. In this case, the controller 170 may determine any one of the edge slots 910 and 920 in association with the communication event. Herein, the controller 170 may determine any one of the edge slots 910 and 920 by using the identification data of the external device. Accordingly, the controller 170 may determine the color light in association with the identification data. More specifically, the controller 170 may determine whether the identification data is associated with the shortcut slot 920. In addition, if it is determined that the identification data is associated with the shortcut slot 920, the controller 170 may determine the color light of the shortcut slot 920. Meanwhile, if it is determined that the identification data is not associated with the shortcut slot 920, the controller 170 may determine color light of the handler slot 910.

Next, in operation 623, the controller 170 may output the color light to the edge region 153. In this case, the controller 170 may output the color light to any one of the edge slots 910 and 920. For example, the controller 170 may output the color light as shown in FIG. 23. Thereafter, the controller 170 may end the procedure of performing the communication event notification operation, and may return to FIG. 3.

Meanwhile, if it is determined in operation 611 that there is no need to notify the communication event in the main region 151, the controller 170 proceeds to operation 621. In addition, the controller 170 performs operations 621 and 623. Thereafter, the controller 170 may end the procedure of performing the communication event notification operation, and may return to FIG. 3.

Meanwhile, if it is determined in operation 315 that the touch event is not associated with the handler slot 810, the controller 170 may determine whether the touch event is associated with the shortcut slot 920 in operation 327. Herein, the controller 170 may determine whether an initial touch location of the touch event corresponds to the shortcut slot 920. In addition, the controller 170 may determine whether the touch event is associated with a movement of a touch from the shortcut slot 920 to the main region 151.

Next, if it is determined in operation 327 that the touch event is associated with the shortcut slot 920, the controller 170 confirms the communication event in operation 329. For example, the controller 170 may notify the communication event as shown in FIG. 24A, FIG. 24B, FIG. 26A, FIG. 26B, FIG. 26C, FIG. 26D, FIG. 26E, FIG. 27, and FIG. 28. Accordingly, the procedure of performing the communication method of the electronic device 100 according to the exemplary embodiment of the present invention may end.

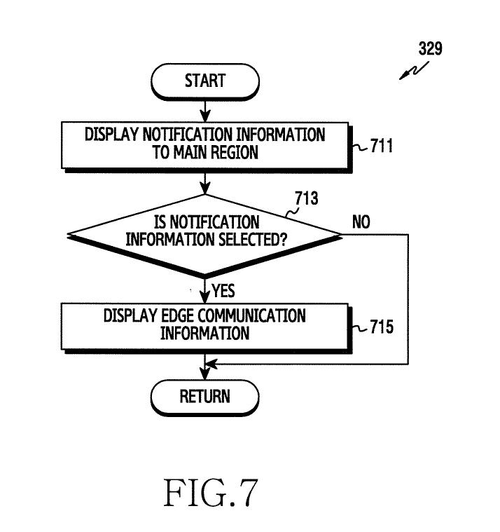

FIG. 7 is a flowchart illustrating a first example of a procedure of performing a communication event confirmation operation of FIG. 3.

Referring to FIG. 7, in the procedure of performing the communication event configuration operation in the present exemplary embodiment, in operation 711, the controller 170 displays notification information of a communication event in the main region 151. For example, the controller 170 may display an edge notification window 2400 to the main region 151 as shown in FIG. 24A, FIG. 24B. Herein, the controller 170 may extend the edge notification window 2400 along a movement of a touch from the shortcut slot 920 to the main region 151. In addition, the controller 170 may display the notification information to the edge notification window 2400. That is, the controller 170 may extend the edge notification window 2400 in the main region 151 as shown in FIG. 24A. Herein, the controller 170 may display an identification image 2410 to an inner portion of the edge notification window 2400 in association with an external device. Further, if the edge notification window 2400 is extended by a pre-set length, the controller 170 may display the notification information to the edge notification window 2400 as shown in FIG. 24B. Herein, the controller 170 may display the identification image 2410 to an outer portion of the edge notification window 2400 in association with the external device.

Next, if the notification information is selected, the controller 170 detects this in operation 713. Herein, if the notification information is selected in the edge notification window 2400, the controller 170 may detect this. Further, the controller 170 may display edge communication information in operation 715. In this case, the edge communication information may indicate specific information of the communication event. Further, the edge communication information may include sensitivity data. Accordingly, the controller 170 may output an object in association with the identification image 1030 of the external device by analyzing the sensitivity data. Herein, the sensitivity data may include at least any one of time information and location information. Further, the object may include at least any one of a vibration, a sound, an image, an animation, and a drawing. For example, the object may include at least any one of a radio wave and a particle. Furthermore, the particle may include at least any one of a petal and a light emitting particle. Thereafter, the controller 170 may end the procedure of performing the communication event notification operation, and may return to FIG. 3.

For example, the controller 170 may detect an output time of at least one of radial waves 2610, 2620, and 2630 from the sensitivity data. In addition, the controller 170 may display the identification image of the external device as shown in FIG. 26A. Further, the controller 170 may generate the radial waves 2610, 2620, and 2630 in the identification image 1030 at the output time as shown in FIGS. 26B, 26C, 26D, and 26E, and may move the radial waves to an outer portion of the identification image 1030. Accordingly, the controller 170 may extinguish the radial waves 2610, 2620, and 2630 from the identification image 1030.

Meanwhile, the controller 170 may continuously generate the plurality of radial waves 2610, 2620, and 2630. That is, the controller 170 may generate the radial waves 2610, 2620, and 2630 at respective output times. In addition, the controller 170 may display the radio waves 2610, 2620, and 2630 in association with the identification image 1030. Further, the controller 170 may move the radial waves 2610, 2620, and 2630 continuously to an outer portion of the identification image 1030. Accordingly, the controller 170 may sequentially extinguish the radial waves 2610, 2620, and 2630 from the identification image 1030.

Herein, according to a time difference between the detection times and an order of the detection times, the controller 170 may determine colors of the radial waves 2610, 2620, and 2630. That is, on the basis of the time difference between the detection times and the order of the detection times, the controller 170 may change at least any one of hue, saturation, or brightness of the radial waves 2610, 2620, and 2630. Alternatively, according to the time difference between the detection times and the order of the detection times, the controller 170 may add a color to the identification image 1030. That is, on the basis of the time difference of the detection times and the order of the detection times, the controller 170 may change at least any one of hue, saturation, and brightness of the identification image 1030. Alternatively, according to the time difference of the detection times and the order of the detection times, the controller 170 may vibrate the identification image 1030 within a pre-set range. That is, on the basis of the time difference between the detection times and the order of the detection times, the controller 170 may change a vibration range of the identification image 1030. For example, the controller 170 may change at least any one of hue, saturation, and brightness of the identification image 1030 as shown in FIG. 26D. Alternatively, the controller 170 may change the vibration range of the identification image 1030 as shown in FIG. 26D.

Alternatively, the controller 170 may detect an output location of at least one petal 2700 from the sensitivity data. In addition, the controller 170 may generate the petal 2700 from the identification image 1030 of the external device as shown in FIG. 27. More specifically, the controller 170 may allow the petal 2700 to come out from the output location of the identification image 1030. Herein, the controller 170 may allow the petal 2700 to continuously come out along a movement path based on the output location.

Alternatively, the controller 170 may detect the output location of at least one light emitting particle 2800 from the sensitivity data. In addition, the controller 170 may generate the light emitting particle 2800 from the identification image 1030 of the external device as shown in FIG. 28. More specifically, the controller 170 may allow the light emitting particle 2800 to come out from the output location of the identification image 1030. Herein, the controller 170 may allow the light emitting particle 2800 to continuously come out along a movement path based on the output location.

Meanwhile, if the shortcut slot 920 is not selected in operation 319, the controller 170 confirms the communication event in operation 329. For this, the edge handler 1000 may further include a handler notification window 2500. For example, if the identification data of the communication event is not associated with the shortcut item 1020, the controller 170 may display the handler notification window 2500 in the edge handler 1000 as shown in FIG. 25A. In addition, the controller 170 may display notification information of the communication event to the handler notification window 2500. Meanwhile, when a plurality of communication events occur in association with a plurality of external devices, the controller 170 may display the notification information of the communication events by displaying a plurality of identification images 2510 in association with a plurality of external devices as shown in FIG. 25B. For example, the controller 170 may notify the communication event as shown in FIG. 26A, FIG. 26B, FIG. 26C, FIG. 26D, FIG. 26E, FIG. 27, and FIG. 28. Accordingly, the procedure of performing the communication method of the electronic device 100 according to the exemplary embodiment of the present invention may end.

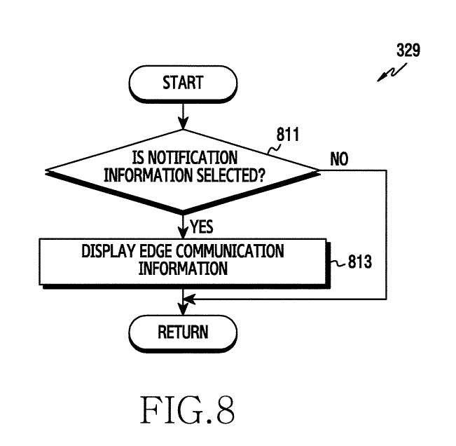

FIG. 8 is a flowchart illustrating a second example of a procedure of performing a communication event confirmation operation of FIG. 3.

Referring to FIG. 8, if the notification information is selected, the controller 170 detects this in operation 811. Herein, if the notification information is selected in the edge handler notification window 2500, the controller 170 may detect this. Further, the controller 170 may display edge communication information in operation 813. In this case, the edge communication information may indicate specific information of the communication event. Further, the edge communication information may include sensitivity data. Accordingly, the controller 170 may output an object in association with the identification image 1030 of the external device by analyzing the sensitivity data. Herein, the sensitivity data may include at least any one of time information and location information. Further, the object may include at least any one of a vibration, a sound, an image, an animation, and a drawing. For example, the object may include at least any one of a radio wave and a particle. Furthermore, the particle may include at least any one of a petal and a light emitting particle. Thereafter, the controller 170 may end the procedure of performing the communication event notification operation, and may return to FIG. 3.

For example, the controller 170 may detect an output time of at least one of radial waves 2610, 2620, and 2630 from the sensitivity data. In addition, the controller 170 may display the identification image of the external device as shown in FIG. 26A. Further, the controller 170 may generate the radial waves 2610, 2620, and 2630 in the identification image 1030 at the output time as shown in FIGS. 26B, 26C, 26D, and 26E, and may move the radial waves to an outer portion of the identification image 1030. Accordingly, the controller 170 may extinguish the radial waves 2610, 2620, and 2630 from the identification image 1030.

Meanwhile, the controller 170 may continuously generate the plurality of radial waves 2610, 2620, and 2630. That is, the controller 170 may generate the radial waves 2610, 2620, and 2630 at respective output times. In addition, the controller 170 may display the radio waves 2610, 2620, and 2630 in association with the identification image 1030. Further, the controller 170 may move the radial waves 2610, 2620, and 2630 continuously to an outer portion of the identification image 1030. Accordingly, the controller 170 may sequentially extinguish the radial waves 2610, 2620, and 2630 from the identification image 1030.

Herein, according to a time difference between the detection times and an order of the detection times, the controller 170 may determine colors of the radial waves 2610, 2620, and 2630. That is, on the basis of the time difference between the detection times and the order of the detection times, the controller 170 may change at least any one of hue, saturation, or brightness of the radial waves 2610, 2620, and 2630. Alternatively, according to the time difference between the detection times and the order of the detection times, the controller 170 may add a color to the identification image 1030. That is, on the basis of the time difference of the detection times and the order of the detection times, the controller 170 may change at least any one of hue, saturation, and brightness of the identification image 1030. Alternatively, according to the time difference of the detection times and the order of the detection times, the controller 170 may vibrate the identification image 1030 within a pre-set range. That is, on the basis of the time difference between the detection times and the order of the detection times, the controller 170 may change a vibration range of the identification image 1030. For example, the controller 170 may change at least any one of hue, saturation, and brightness of the identification image 1030 as shown in FIG. 26D. Alternatively, the controller 170 may change the vibration range of the identification image 1030 as shown in FIG. 26D.

Alternatively, the controller 170 may detect an output location of at least one petal 2700 from the sensitivity data. In addition, the controller 170 may generate the petal 2700 from the identification image 1030 of the external device as shown in FIG. 27. More specifically, the controller 170 may allow the petal 2700 to come out from the output location of the identification image 1030. Herein, the controller 170 may allow the petal 2700 to continuously come out along a movement path based on the output location.

Alternatively, the controller 170 may detect the output location of at least one light emitting particle 2800 from the sensitivity data. In addition, the controller 170 may generate the light emitting particle 2800 from the identification image 1030 of the external device as shown in FIG. 28. More specifically, the controller 170 may allow the light emitting particle 2800 to come out from the output location of the identification image 1030. Herein, the controller 170 may allow the light emitting particle 2800 to continuously come out along a movement path based on the output location.

Meanwhile, if it is determined in operation 313 that the touch event is not generated from the edge region 153, the controller 170 performs a corresponding function in operation 331. In this case, the touch event may occur in the main region 151. In addition, the controller 170 may control the main region 151 in association with the touch event.

According to the present invention, the display unit 150 of the electronic device 100 may include not only the main region 151 but also the edge region 153. Accordingly, a touch operation may occur not only from the main region 151 but also from the edge region 153. As a result, the electronic device 100 may provide various interactions as to various touch operations. That is, the electronic device 100 may control the display screen in association with the various touch operations. Accordingly, usage efficiency and user convenience of the electronic device 100 can be improved.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A communication method of an electronic device, comprising:
displaying an identification image associated with identification data;
recording sensitivity data for outputting an object to the identification image based on a user input associated with the identification image; and
transmitting the recorded sensitivity data.

2. The communication method of claim 1, wherein recording the sensitivity data comprises the recorded sensitivity data is recorded as a text.

3. The communication method of claim 1, wherein the recorded sensitivity data comprises at least any one of time information and location information.

4. The communication method of claim 3, wherein the user input is generated in association with a touch event.

5. The communication method of claim 4,
wherein the time information is determined from a detection time of the touch event, and
wherein the location information is determined from a touch location of the touch event.

6. The communication method of claim 1, further comprising outputting the object to the identification image based on the user input.

7. The communication method of claim 1, wherein the object comprises at least any one of a vibration, a sound, an image, an animation, and a drawing.

8. The communication method of claim 7, wherein the object comprises at least any one of a radial wave that moves to an outer portion from the identification image and a particle generated from the identification image.

9. The communication method of claim 8, wherein the particle comprises at least any one of a petal and a light emitting particle that come out from the identification image.

10. The communication method of claim 1, wherein the recording of the sensitivity data is performed during a pre-set time.

11. The communication method of claim 1, wherein transmitting the sensitivity data comprises the recorded sensitivity data is transmitted by using the identification data.

12. The communication method of claim 1, further comprising:
receiving sensitivity data from an external device;
displaying an identification image associated with the external device; and
outputting an object in association with the displayed identification image by analyzing the received sensitivity data.

13. The communication method of claim 12, wherein receiving the sensitivity data comprises the sensitivity data is received as a text.

14. The communication method of claim 12, wherein the received sensitivity data comprises at least any one of time information and location information.

15. The communication method of claim 14, wherein in the outputting of the object, the object is output based on at least any one of the time information and the location information.

16. An electronic device comprising:
a communication unit;
a display unit; and
a controller coupled to the communication unit and the display unit,
wherein the controller is further configured control to:
display an identification image associated with identification data;
record sensitivity data for outputting an object to the identification image based on a user input associated with the identification image; and
transmit the recorded sensitivity data.

17. The electronic device of claim 16, wherein the controller is further configured to record the recoded sensitivity data as a text.

18. The electronic device of claim 16, wherein the recorded sensitivity data comprises at least any one of time information and location information.

19. The electronic device of claim 18, wherein the user input is generated in association with a touch event.

20. The electronic device of claim 19,
wherein the time information is determined from a detection time of the touch event, and
wherein the location information is determined from a touch location of the touch event.
